(19) United States
(12) Patent Application Publication
(10) Pub. No.: US 2014/0251227 A1
(43) Pub. Date: Sep. 11, 2014

(54) REPTILE BREEDING TANK

(71) Applicant: EIKO ELECTRIC PRODUCTS CORP., TAIPEI (TW)

(72) Inventor: Yu-Chin WANG, Taipei (TW)

(73) Assignee: EIKO ELECTRIC PRODUCTS CORP., Taipei (TW)

(21) Appl. No.: 13/785,164

(22) Filed: Mar. 5, 2013

(51) Int. Cl. A01K 63/00

(52) U.S. Cl. CPC A01K 63/003
USPC 119/266; 119/265

(57) ABSTRACT

A reptile breeding tank includes a tank body formed of a front cage panel, a back cage panel, left and right cage panels, a top cage panel, a bottom cage panel and an arched angle of intersection between the front cage panel and the top cage panel, a back plate detachably mounted at the rear side of the tank body and supported on the back cage panel, and a flip-up top cover hinged to the tank body and turnable between an open position to open the top side of the tank body and a close position to close the top side of the tank body.

### BACKGROUND OF THE INVENTION

1. Field of the Invention

The present invention relates to reptile breeding facilities and more particularly, to a reptile breeding tank that allows the user to open the top side of the tank body for access, or to change the installed scenery subject to the user's preference or the type of reptiles under breeding.

2. Description of the Related Art

A wide variety of reptiles and amphibians, such as iguana, dragon, tortoise, aquatic turtle, phelsuma, dactylus, crickets, grasshoppers, snake, and etc. are living in this world. Recently, the wave of reptile breeding has become a rising trend due to the reason that reptile enthusiasts can observe reptile living environment when breeding reptiles and enjoy the feeling of coming into contact with the wild word.

In the early days, breeding cages were used to breed reptiles. Nowadays, breeding boxes and tanks are used to substitute for breeding tanks for breeding reptiles. Riverbed sand, rain forest bark, jungle soil and plants may be provided in a reptile breeding tank to simulate natural breeding environment, ensuring a healthy growth of breeding reptiles. Further, a reptile breeding tank may be equipped with a lighting fixture to simulate daylight and to keep cold blooded reptiles warm. Providing light to breeding reptiles is an important breeding condition.

Conventional reptile breeding boxes and tanks are commonly made out of see-through materials (for example, glass), comprising a rectangular box body or tank body having four transparent upright peripheral panels at the four sides and a solid bottom panel, and a top cover mounted at the open top side of the box body or tank body and adapted to open/close the top opening of the box body or tank body. Normally, the four transparent upright peripheral panels are planar members. Thus, the entire rectangular tank body renders a visual effect that is more monotonous, poor and unsightly. If the owner stands away from the reptile breeding box or tank at a distance and views the breeding reptiles in the reptile breeding box or tank, the right angle intersection between the horizontal top panel and upright front panel of the tank body will hinder the sight too much. Further, people usually put their reptile breeding boxes or tanks in the house. The monotonous configuration of conventional reptile breeding boxes or tanks may be unable to match with surrounding indoor decorations, and cannot provide ornamental effects.

Further, if the top cover of a reptile breeding box or tank is equipped with a lighting fixture and a heater, it will be very inconvenient to open the top cover and to feed breeding reptiles.

### SUMMARY OF THE INVENTION

The present invention has been accomplished under the circumstances in view. It is one object of the present invention to provide a reptile breeding tank, which matches indoor surroundings, providing optimal decorative effects.

It is another object of the present invention to provide a reptile breeding tank, which allows opening the top side of the tank body for access to the inside of the tank body to give feeding supplies to the reptiles under breeding.

It is still another object of the present invention to provide a reptile breeding tank, which allows change of the installed scenery subject to user's preference or the type of reptiles under breeding.

To achieve these and other objects of the present invention, a reptile breeding tank comprises a tank body, a back plate, and a flip-up top cover. The tank body comprises a front cage panel located at the front side thereof, a back cage panel located at the rear side thereof, a left cage panel located at the left side thereof and connected between the front cage panel and the back cage panel, a right cage panel located at the right side thereof and connected between the front cage panel and the back cage panel, a top cage panel located at the top side thereof and connected between the left cage panel and the right cage panel, an arched angle of intersection provided between the top cage panel and the front cage panel and a bottom cage panel located at the bottom side thereof between the front cage panel and the back cage panel and between the left cage panel and the right cage panel. The back cage panel has a height shorter than the left cage panel and the right cage panel. The back plate is detachably mounted in the rear side of the tank body between the left cage panel and the right cage panel, and stopped at the topmost edge of the back cage panel. The flip-up top cover is hinged to the tank body, and movable between an open position to open the top side of the tank body and a close position to close the top side of the tank body.

Preferably, the tank body further comprises a left upright bracket and a right upright bracket respectively mounted at the inner rear side of the left cage panel and the inner rear side of the right cage panel and supported on the topmost edge of the back cage panel. The left upright bracket and the right upright bracket each comprise a flanged longitudinal mounting portion disposed at an outer side thereof and respectively affixed to the left cage panel and the right cage panel, a longitudinal mounting groove disposed at an inner side thereof for receiving the back plate, and a pivot housing disposed at a top side thereof. The flip-up top cover comprises two barrels located at a rear side thereof and respectively pivotally coupled to the pivot housings of the left upright bracket and the right upright bracket by a respective pivot pin.

Preferably, the flip-up top cover comprises at least one lighting device mounted at an inner wall thereof.

Further, each lighting device is preferably a LED lighting device mounted at the inner wall of the flip-up top cover by means of surface mount technology.

Preferably, each LED lighting device comprises a plurality of light-emitting diodes of different colors.

Preferably, the flip-up top cover further comprises an inner rim protruded from the inner wall thereof, and two locating boxes mounted at the inner wall thereof within the inner rim to hold down the at least one lighting device in place. Further, each locating box defines a recessed accommodation area for receiving electrical wires and component parts of the at least one lighting device.

### BRIEF DESCRIPTION OF THE DRAWINGS

FIG. 1 is a perspective view of a reptile breeding tank in accordance with the present invention.

FIG. 2 is a perspective view of the present invention, illustrating the flip-up top cover opened.

FIG. 3 is an exploded view of the reptile breeding tank in accordance with the present invention.

FIG. 4 is a sectional view of the flip-up top cover of the reptile breeding tank in accordance with the present invention.

FIG. 5 is a cutaway view, in an enlarged scale, of a part of the flip-up top cover of the reptile breeding tank in accordance with the present invention.

FIG. 6 is a schematic drawing illustrating one application example of the reptile breeding tank in accordance with the present invention.

FIG. 7 is a schematic drawing illustrating another application example of the reptile breeding tank in accordance with the present invention.

### DETAILED DESCRIPTION OF THE PREFERRED EMBODIMENT

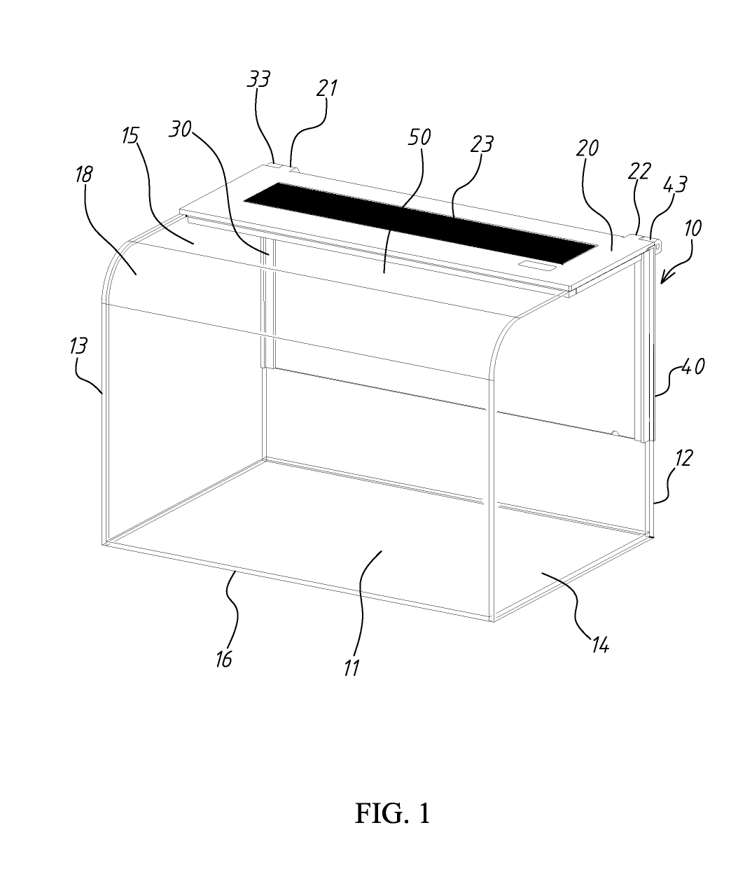

Referring to FIG. 1, a reptile breeding tank in accordance with the present invention is shown. The reptile breeding tank comprises a tank body 10, and a flip-up top cover 20. The tank body 12 comprises a front cage panel 11, a back cage panel 12, a left cage panel 13, a right cage panel 14, a top cage panel 15 and a bottom cage panel 16. The back cage panel 12 is connected to the rear side of the bottom cage panel 16 between the left cage panel 13 and the right cage panel 14, having a height much shorter than the left cage panel 13 and the right cage panel 14.

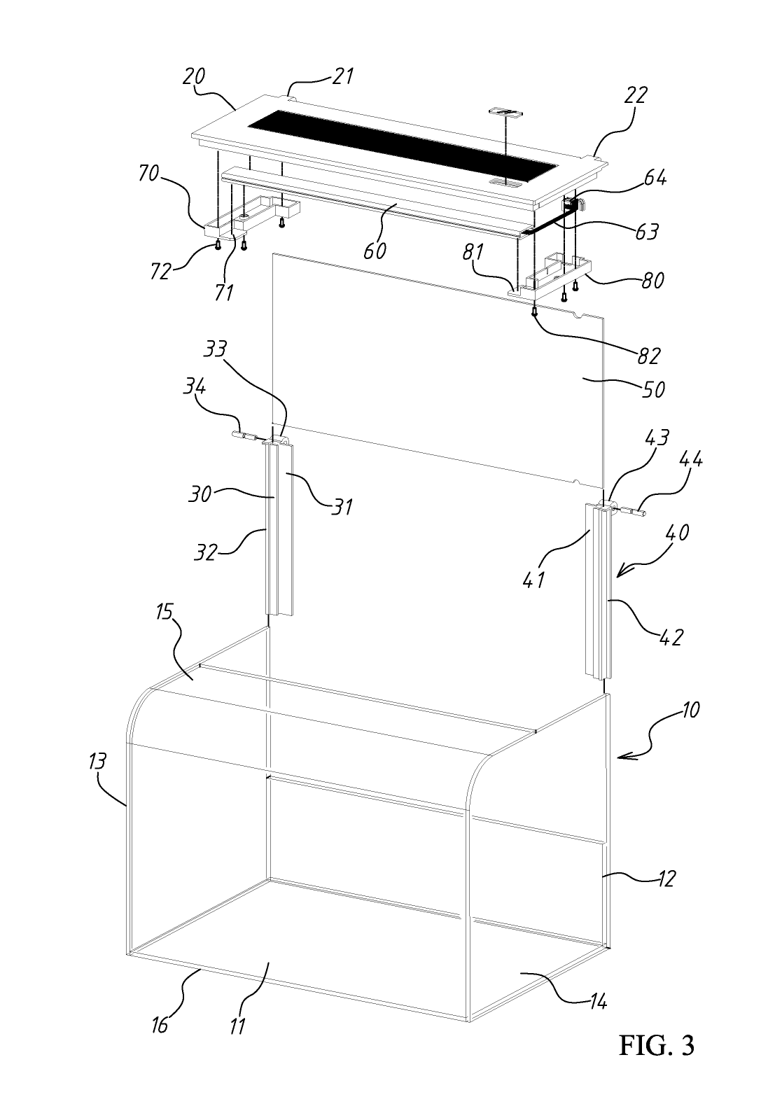

Referring to FIGS. 2 and 3 and FIG. 1 again, the front cage panel 11 and the top cage panel 15 can be made in one piece, providing an arched angle of intersection 18 therebetween, optimizing the viewing angle. Further, the top cage panel 15 and the flip-up top cover 20 cover the whole top side of the reptile breeding tank.

Further, a left upright bracket 30 and a right upright bracket 40 are respectively mounted at the inner rear side of the left cage panel 13 and the inner rear side of the right cage panel 14 and supported on the topmost edge of the back cage panel 12 of the tank body 1, each comprising a flanged longitudinal mounting portion 32 or 42 disposed at an outer side thereof and affixed to the left cage panel 13 or right cage panel 14 by, for example, silicon adhesive, a longitudinal mounting groove 31 or 41 disposed at an inner side thereof, and a pivot housing 33 or 43 disposed at a top side thereof. Further, a back plate 50 is inserted into the longitudinal mounting grooves 31 and 41 and stopped against the topmost edge of the back cage panel 12 of the tank body 1. Thus, the back plate 50 and the back cage panel 12 cover the whole back side of the reptile breeding tank. Further, two pivot pins 34 and 44 are respectively mounted in the pivot housings 33 and 43 and respective barrels 21 and 22 at the rear side of the flip-up top cover 20 to pivotally connect the flip-up top cover 20 to the left upright bracket 30 and the right upright bracket 40.

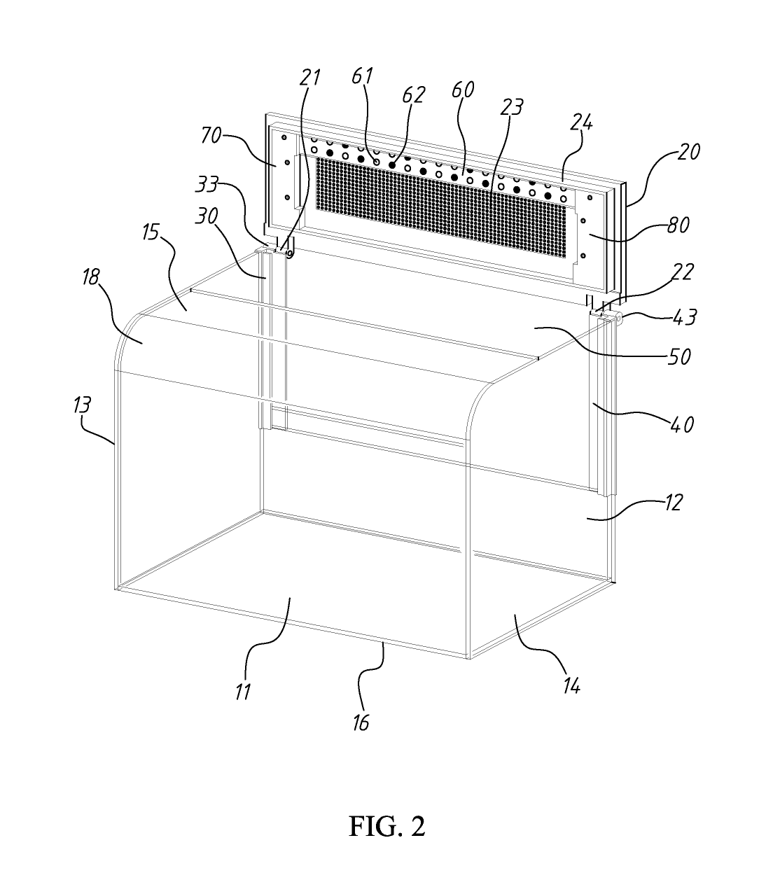

The flip-up top cover 20 further comprises a ventilation grill 23 for allowing circulation of air between the inside space of the tank body 10 and the atmosphere, and a lighting device 60 mounted at the inner wall thereof by means of surface mount technology. In this embodiment, the lighting device 60 is a LED lamp comprising a plurality of light-emitting diodes of different colors, for example, white LEDs 61 and blue LEDs 62 arranged in an array (see FIG. 2).

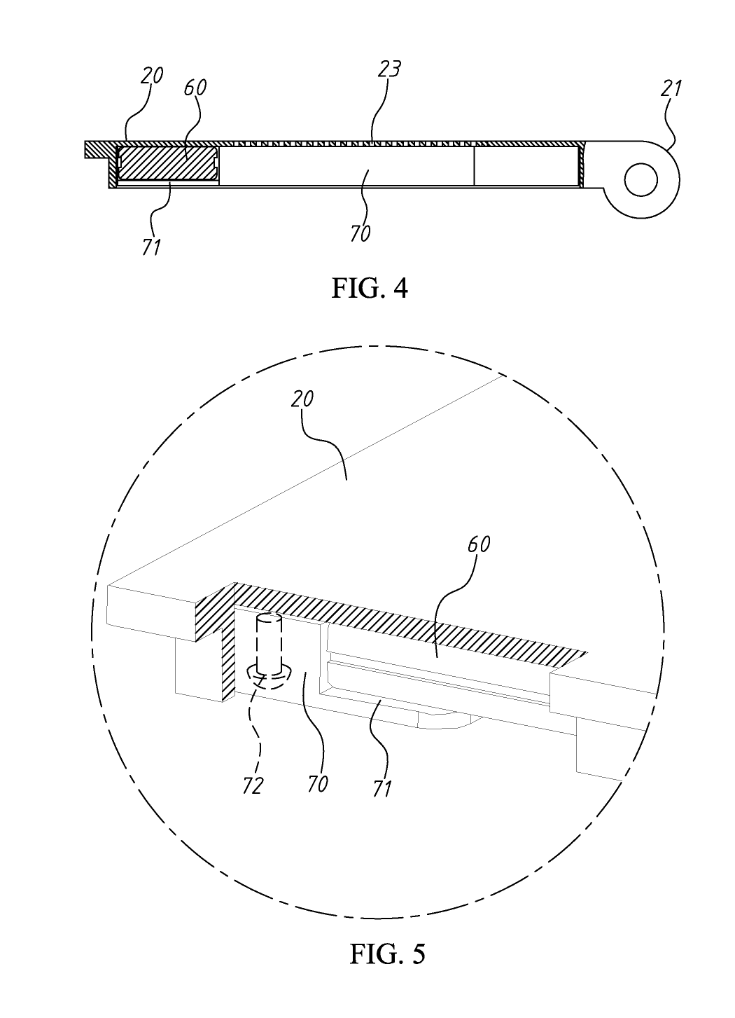

Referring to FIGS. 4 and 5 and FIGS. 2 and 3 again, the flip-up top cover 20 further comprises an inner rim 24 protruded from the inner wall thereof, and two locating boxes 70 and 80 mounted within the inner rim 24 and affixed in place by respective screws 72 and 82 to hold electrical wires 63 and related components 64 of the lighting device 60 in recessed accommodation areas 71 and 81 therein.

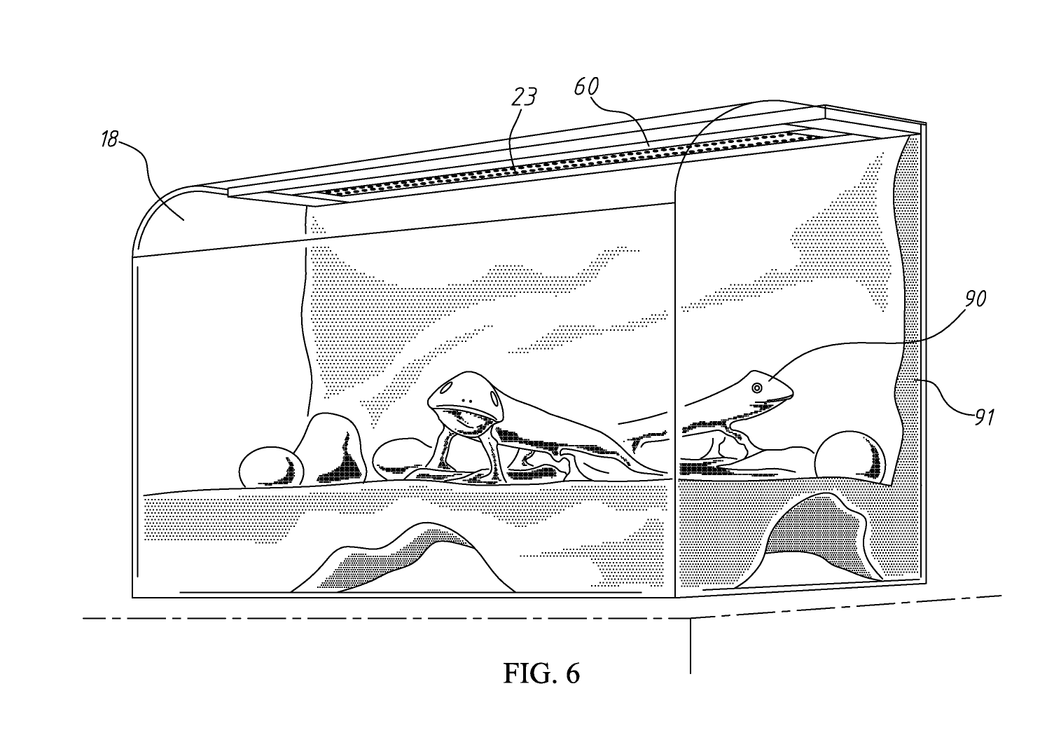

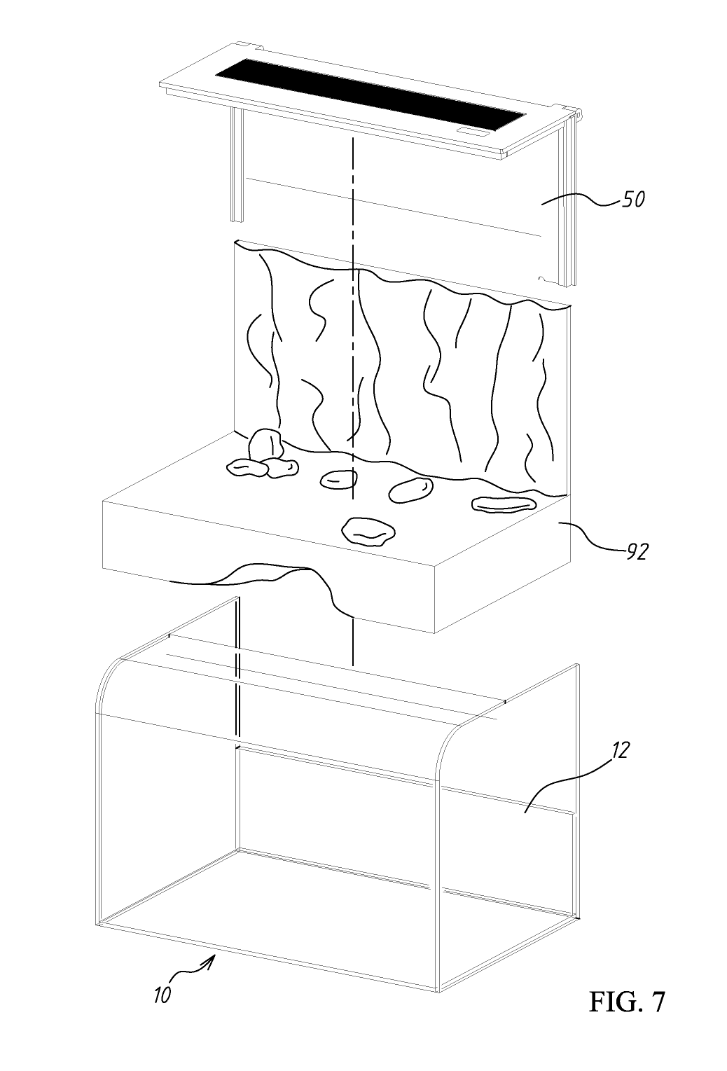

Referring to FIG. 6, scene materials 91 and reptiles 90 are put in the tank body 10 of the reptile breeding tank. At this time, currents of air can go through the ventilation grill 23 between the inside space of the tank body 10 and the atmosphere, the arched angle of intersection 18 between the front cage panel 11 and the top cage panel 15 provides an optimized viewing angle, and the lighting device 60 is controllable to emit light, selectively simulating different lighting environments.

Referring to FIG. 7, subject to the detachable arrangement of the back plate 50 at the top side of the back cage panel 12 of the tank body 10 and the flip-up design of the top cover 20, different scenery 91 and 92 can be conveniently a moved in and out of the tank body 10 and selectively mounted inside the tank body 10. Further, the scenery 91 and 92 can be made out of cold porcelain paste, and used as a feeding dish. Thus, the user can change the scenery 91 or 92 subject to one's preference or the type of reptiles under breeding.

As stated above, the invention provides a reptile breeding tank, which, subject to the design of the arched angle of intersection between the front cage panel and the top cage panel, causes a sense of beauty and renders an optimized visual effect to match with surrounding indoor decorations without hindering people's viewing angle. Further, the flip-up design of the top cover facilitates access to the inside of the tank body to feed breeding reptiles.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A reptile breeding tank, comprising:
a tank body comprising a front cage panel located at a front side thereof, a back cage panel located at a rear side thereof, a left cage panel located at a left side thereof and connected between said front cage panel and said back cage panel, a right cage panel located at a right side thereof and connected between said front cage panel and said back cage panel, a top cage panel located at a top side thereof and connected between said left cage panel and said right cage panel, an arched angle of intersection provided between said top cage panel and said front cage panel and a bottom cage panel located at a bottom side thereof between said front cage panel and said back cage panel and between said left cage panel and said right cage panel, said back cage panel having a height shorter than said left cage panel and said right cage panel;
a back plate detachably mounted in the rear side of said tank body between said left cage panel and said right cage panel and stopped at the topmost edge of said back cage panel; and
a flip-up top cover hinged to said tank body and movable between an open position to open a top side of said tank body and a close position to close the top side of said tank body.

2. The reptile breeding tank as claimed in claim 1, wherein said tank body further comprises a left upright bracket and a right upright bracket respectively mounted at an inner rear side of said left cage panel and an inner rear side of said right cage panel and supported on the topmost edge of said back cage panel, said left upright bracket and said right upright bracket each comprising a flanged longitudinal mounting portion disposed at an outer side thereof and respectively affixed to said left cage panel and said right cage panel, a longitudinal mounting groove disposed at an inner side thereof for receiving said back plate, and a pivot housing disposed at a top side thereof; said flip-up top cover comprises two barrels located at a rear side thereof and respectively pivotally coupled to the pivot housings of said left upright bracket and said right upright bracket by a respective pivot pin.

3. The reptile breeding tank as claimed in claim 1, wherein said flip-up top cover comprises at least one lighting device mounted at an inner wall thereof.

4. The reptile breeding tank as claimed in claim 3, wherein each said lighting device is a LED lighting device mounted at the inner wall of said flip-up top cover by means of surface mount technology.

5. The reptile breeding tank as claimed in claim 4, wherein each said LED lighting device comprises a plurality of light-emitting diodes of different colors.

6. The reptile breeding tank as claimed in claim 3, wherein said flip-up top cover further comprises an inner rim protruded from the inner wall thereof, and two locating boxes mounted at the inner wall thereof within said inner rim to hold down said at least one lighting device in place, each said locating box defining a recessed accommodation area for receiving electrical wires and component parts of said at least one lighting device.
